(19) United States
(12) Patent Application Publication
(10) Pub. No.: US 2008/0212877 A1
(43) Pub. Date: Sep. 4, 2008

(54) HIGH SPEED ERROR DETECTION AND CORRECTION FOR CHARACTER RECOGNITION

(76) Inventor: John Franco, Denver, CO (US)

Correspondence Address: TRENNER LAW FIRM, LLC, 12081 WEST ALAMEDA PARKWAY #163, LAKEWOOD, CO, 80228, US

(21) Appl. No.: 12/039,915

(22) Filed: Feb. 29, 2008

Related U.S. Application Data
(60) Provisional application No. 60/892,870, filed on Mar. 4, 2007.

(51) Int. Cl. G06K 9/18

(52) U.S. Cl. 382/182

(57) ABSTRACT

Systems and methods for high speed error detection and correction are disclosed. An exemplary method may include grouping character images (ci) by suspected character code (cc) to generate a set of CI(cc). The method may also include displaying the set of CI(cc) for manual verification. The method may also include determining a set of RS(cc) of representative shapes (rs) of character images codes for each CI(cc). The method may also include displaying the set of RS(cc) for manual verification.

### PRIORITY APPLICATION

This application claims priority to co-owned U.S. Provisional Patent Application Ser. No. 60/892,870 for “High Speed Error Detection And Correction For Character Recognition” of John Franco (Attorney Docket No. 1100.001.PRV), filed Mar. 4, 2007 and hereby incorporated by reference as though fully set forth herein.

### BACKGROUND

Paper forms, checks, receipts, or other documents (generally referred to herein as “documents”) may be converted to electronic format using a combination of manual and automatic processes. For example, a paper document may be converted to an electronic image by one or more imaging devices. The document's electronic images may then be analyzed by any combination of a wide variety of character recognition software or hardware processes to produce text output consisting of the character codes corresponding to each character image. This process goes by many names, but is sometimes referred to as Intelligent Character Recognition (ICR), or more commonly, Optical Character Recognition (OCR).

For the purpose of the discussion herein, “documents” are made up of one or more “pages”, where a page is a single side of a piece of paper. Although most OCR procedures are reasonably accurate, there may still be errors, such as, but not limited to, outputting the wrong character code, missing characters on the page, merging multiple characters on the page into a single and incorrect character, misinterpreting noise or pictures as one or more characters, and misinterpreting parts of a single character as individual characters and outputting several incorrect characters. Consequently, human intervention may still be needed to locate and correct errors after initial processing by the OCR software to gain an acceptable level of accuracy.

In many cases, automatic validation of some of the OCR results can be performed. This may include, but is not limited to lookup tables or context based techniques. For the remaining OCR data that has not been automatically verified, manual data verification/correction techniques may be implemented.

According to one such manual process, the OCR result is displayed next to a full or partial view of the electronic image of the original page for visual inspection and manual correction by an operator. Some systems show just the character in question, while others show the entire word containing the character in question. When showing the entire word, the character in question may be highlighted in the OCR result or in the image to aid the user.

This correction process is labor intensive and error prone for various reasons. For example, the OCR engine is relied upon to flag questionable characters; however, the OCR engine can incorrectly flag good results as bad or vice-versa. Consequently, the operator must waste time reviewing good results and is never have the opportunity to review some of the bad results. This means that even with the extra review required, the operator is unable to correct all the mistakes. For higher accuracy, the threshold at which a character is considered good can be lowered so that more OCR results are reviewed. In fact, the threshold can be lowered to the point that all of the OCR results are reviewed. However, this increase in accuracy comes at a prohibitive increase in time and cost.

In addition, the operator must read the OCR result and then the corresponding word on the image to locate corrections. This means that two human reads are necessary for every OCR result. Furthermore, every word is different and therefore there are no patterns that the operator can rely on and errors do not stand out to the operator. Even when flagging characters in question for the operator, correct characters may be flagged as incorrect or vice versa, so the operator always has to compare the entire word. The repetitive nature of these techniques and because errors do not stand out may result in lower accuracy.

Even if a single character is wrong, the operator still may find it easier to correct the entire word containing the incorrect character because good typists often can key in an entire word faster than they can highlight and replace a single character.

### BRIEF DESCRIPTION OF THE DRAWINGS

FIG. 1 is a high level diagram of a system which may implement high speed error detection and correction.

FIG. 2 is a process flow diagram illustrating exemplary operations which may be implemented for high speed error detection and correction.

FIGS. 3a-b are illustrations showing an exemplary embodiment for determining representative shapes within a group of character images.

FIG. 4 is an example of what the rs within a PVRS might look like and how PVRS can automatically validate CI.

FIGS. 5a-b show exemplary matrices which may be displayed for a used for manual validation during high speed error detection and correction, wherein a) shows a character image (CI) matrix, and b-c) shows the CI matrix after it has been reduced to a representative shapes (rs) matrix.

FIGS. 6a-b show other exemplary matrices which may be displayed for a user for manual validation during high speed error detection and correction, wherein a) shows an rs-word matrix containing all the words for a single rs, and (b) shows a ci-word matrix containing all the words for a CI(cc).

### DETAILED DESCRIPTION

Systems and methods of high speed error detection and correction for character recognition are disclosed. In an exemplary embodiment, batches of one or more paper documents are imaged and optical character recognition (OCR) is performed on regions of each image or the entirety of each image. Initial validation of the OCR result may be performed to reduce the number of characters that need to be manually reviewed.

The remaining non-validated character images (ci's), may be “cut out” of the images and grouped by their character codes (cc's) that were determined by the initial OCR process. The term “ci” refers to an individual character image. The term “CI” refers to a set of character images. The term “cc” refers to an individual character code. The term “CC” refers to a set of character codes.

The shape of each ci may then be compared to the set of other shapes with the same suspected cc, CI(cc). Because most of the ci with the same cc may be quite similar to each other, a much smaller set of representative shapes (RS) for each cc, RS(cc), can be determined. Each ci is then mapped to its most similar representative shape (rs) within RS(cc). The term “rs” refers to an individual representative shape. “RS” refers to a set of representative shapes.

Certain rs's within RS(cc) may be automatically verified by processes described below and removed from RS(cc). What remains of RS(cc) may then be presented to the operator in any arrangement, with the preferred embodiment being a grid, for inspection and correction. The presentation of an rs may be in a “composite” or “representative” style.

Systems and methods of high speed error detection and correction for character recognition may be better understood from the following discussion with reference to the drawings.

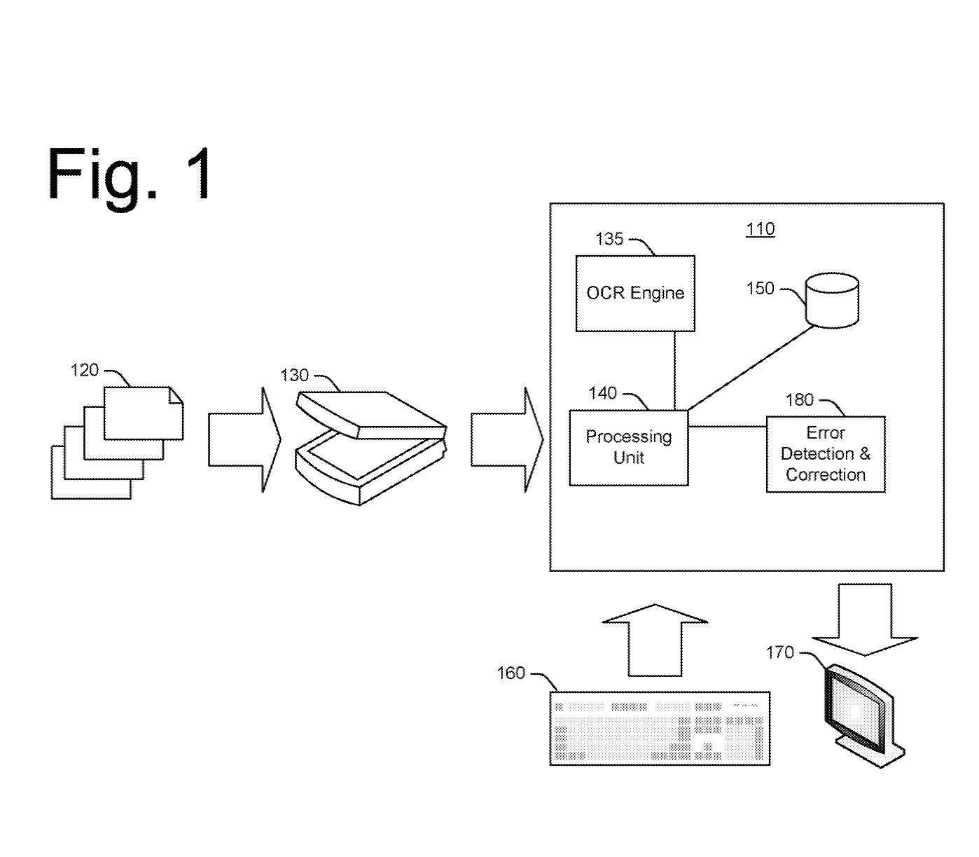

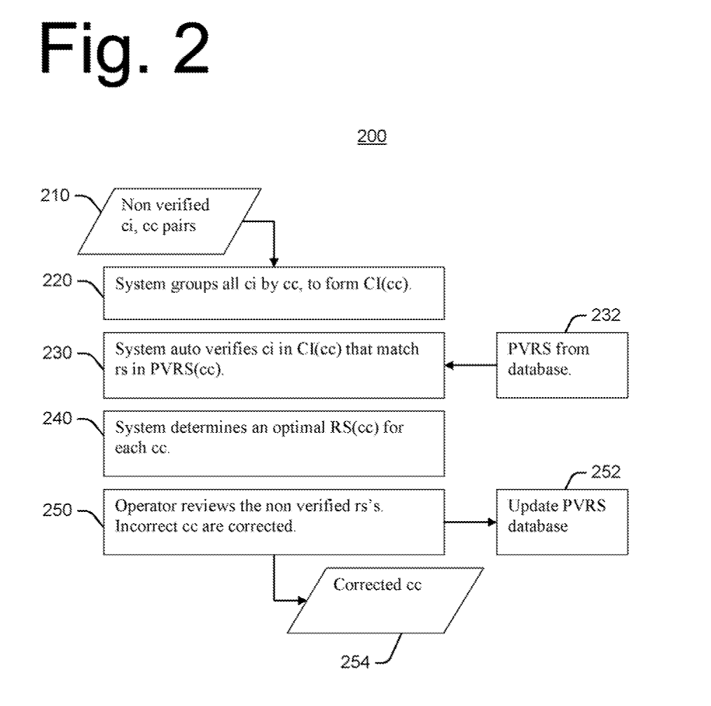

FIG. 1 is a high level diagram of a system 100 which may implement high speed error detection and correction. The system 100 may be implemented as a conventional computer, a distributed computer, or any other type of computer generally referred to herein as a computing device 110. Data from one or more documents 120 may be input to the computing device 110 via scanning or other imaging device 130, or by other means (e.g., by removable or non-removable storage media or as data packets received over a network). An OCR engine 135 may be provided as part of the computing device 110 and/or imaging device 130 for converting imaged data from the document(s) 120 into characters.

An exemplary computing device 110 may include at least one processing unit 140 (e.g., a microprocessor or microcontroller), and memory or data storage 150. Memory 150 may include without limitation read only memory (ROM) and random access memory (RAM), hard disk storage, removable media such as compact disc (CD) or digital versatile disc (DVD) storage, and/or network storage.

The computing device 110 may also include an I/O section optionally connected to a keyboard 160, mouse or other input device (not shown), and display device 170 for user interaction, although it is not limited to these devices. The computing device may also operate in a networked environment using logical connections to one or more remote computers. Exemplary logical connections include without limitation a local-area network (LAN) and a wide-area network (WAN). Such networking environments are commonplace in office networks, enterprise-wide computer networks, intranets and the Internal, which are all exemplary types of networks.

As is well understood in the computer arts, computing device 110 can read data and program files, and execute program code. The program code 180 for high speed error detection and correction described herein may be implemented in software or firmware modules loaded in memory and/or stored on a configured CD, DVD, or other storage unit. When executed, the program code transforms the computing device 110 into a special purpose machine for implementing high speed error detection and correction.

Before continuing, it is noted that the exemplary system 100 shown in FIG. 1 is provided merely for purposes of illustration and is not intended to be limiting in any way. Other embodiments of systems, now known or later developed, which may implement high speed error detection and correction as described herein, is also be readily apparent to those having ordinary skill in the art after becoming familiar with the teachings herein.

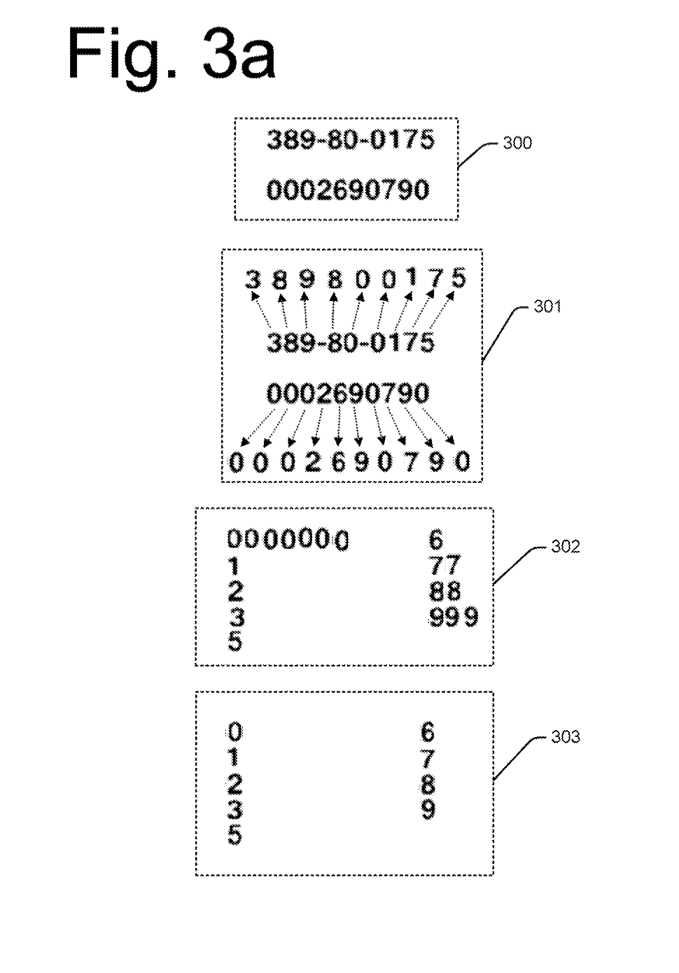

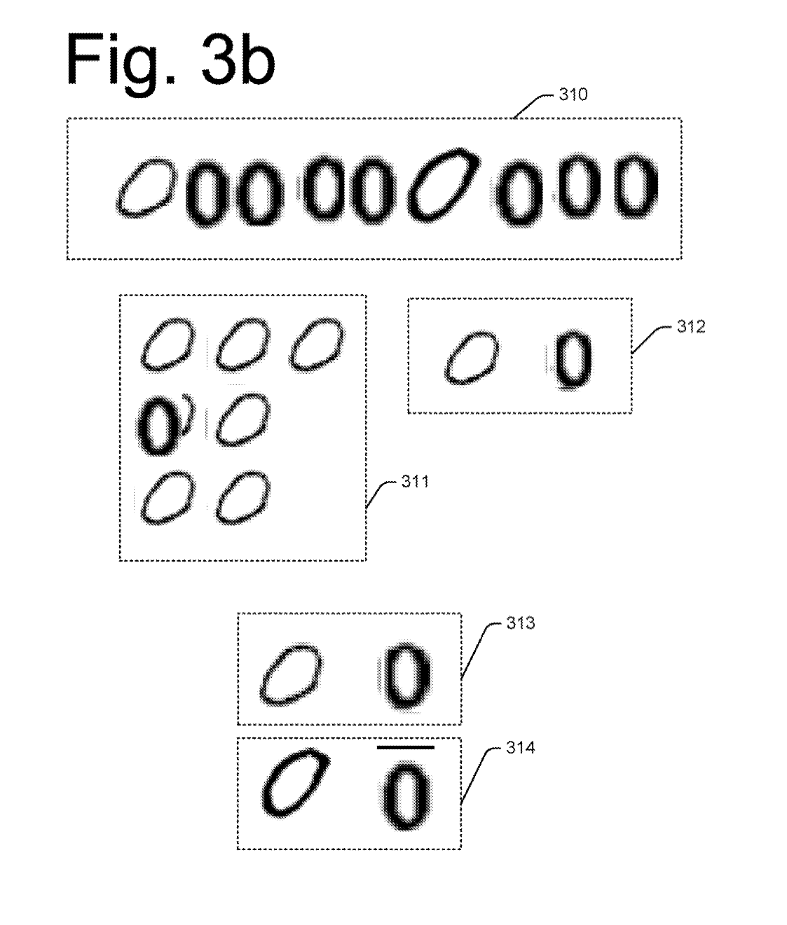

As described briefly above, the system 100 may be used to image one or more paper document and perform OCR to convert the image data into characters. FIG. 2 is a process flow diagram illustrating exemplary operations which may be implemented for high speed error detection and correction. The exemplary operations may be embodied as logic instructions on one or more computer-readable mediums. When executed on a processor, the logic instructions cause a general purpose computing device to be programmed as a special-purpose machine that implements the described operations. Operations shown in FIG. 2 are also described with reference to illustrative examples shown in FIGS. 3a-b, 4, 5a-b, and 6a-b.

Input data 210 may originate from an OCR process having been applied to images of one or more documents (although, the input data can come from any process). In an exemplary embodiment, the input data 210 may include ci/cc pairs. Character codes are commonly the ASCII or Unicode code of a character; however, any coding scheme may be used.

Input data for each ci/cc pair may also include, but is not limited to, the coordinates of the ci within its word; the coordinates of the ci within its page; the image of the ci's word; the coordinates of the ci's word within its page; the sequence of the ci within its word's text; the sequence of the word within its page's text; the image of the ci's page; the OCR confidence for a cc; links to previous and/or next ci/cc pair; links to previous and/or next word; document, page, batch, and/or field types and/or id's; and/or a lexical database for a field, page, document, and/or batch. Certain input data is required to perform certain steps in the process. These steps can be skipped or substituted with other steps that are not as efficient.

It is also noted that a page image may be the file name of a page image, rather than the image data. A word image may be the coordinates of the word within its page image, rather than the image data. A ci may be the coordinates of the ci within its word or its page, rather than the image data. A word image can be reconstructed from the ci's if enough ci location information is provided. A page image can be reconstructed from its word images if enough word image location information is provided.

An alternate method of obtaining the source data consisting of source images and associated OCR data is described. If character image segmentation data is available for one or more electronic images, but the OCR has not been performed, it is possible to determine a set of rs's, RS(CI), for the set of all of the ci's from all the electronic images or regions of interest on those images, CI, without knowledge of the associated cc's. This may be implemented in situations where the page images are put through a segmentation process but the segmented ci's have not been recognized by OCR. The OCR might be done on RS(CI) rather than all of the page images. The end result is the complete set of source data.

Initial validation of the OCR results may be performed to reduce the number of characters that need to be manually reviewed. This may include automatic and/or manual repair and/or validation of incorrect OCR results. An example might be the use of a validation table to verify entries in a field of a form. A second example might be the use of a formula to validate a field or fields within a form. Still other methods of data validation may be used.

The remaining non-validated ci's are “cut out” of their originating document's images, as can be seen in the example of FIGS. 3a-b. FIGS. 3a-b are illustrations showing an exemplary embodiment for determining representative shapes within a group of character images 300. Segmentation 301 is the process of finding the boundary of each individual character. Segmentation 301 is typically performed by the OCR engine as part of the OCR process, although it may also be performed separately. Due to OCR errors, the ci may be associated with the wrong cc. For example, since the ci segmentation process 301 is automatic, ci's may be partial images of characters, images of “garbage,” images of more than one character, etc., a combination of these, or blank.

In operation 220 (FIG. 2), the system may group all ci's (e.g., by cc), as illustrated by groupings 302 in FIG. 3a. These groups are referred to as sets of ci's (denoted “CI”), or sets of ci's for each cc, (denoted “CI(cc)”). Each CI(cc) contains all of the ci's having the same cc. An example CI(cc) is a set of all the ci's the OCR engine “thought” were images of the letter “q”, CI(cc=q). It is noted that there are different cc's for upper and lower case characters. Grouping by cc's is an exemplary method to partition the entire set of ci's. Although not required, this method is advantageous because: 1) the operator knows the ci⇄cc relationship for an entire group of ci without having to look back and forth between the ci and cc for each ci/cc pair; 2) incorrectly recognized ci's stand out since they have vastly different shapes compared to the majority of ci's surrounding them; and 3) the processing required in later steps is reduced.

It is noted that CI is the set of all of the ci's from one or more pages of one or more documents spanning one or more batches. The larger the input set, the greater the productivity of the system. The number pages processed at one time may depend on design considerations, as larger input sets is take longer for the system to prepare, but would increase operator productivity. Assume RS is the set of all rs's required for the entire input set. For a given minimum error when mapping the ci's to their closest rs's 303, the size of RS, |RS|, is a function of font similarity and the number of characters within the input set, as illustrated with reference to FIG. 3b.

In FIG. 3b, a number of ci's (0's) 310 are shown grouped by cc. Next, an RS is found, wherein the ci's 311 are not the same, and the ci's 312 are the same. Accordingly, the resulting RS includes composite style 313 and representative style 314.

Consequently, increasing font similarity decreases |RS|. Furthermore, the number of characters increases |RS|. In a forms processing scenario, where only a small number of words are being extracted from a page, 100-1000 pages may be a good input range. In a full page OCR scenario, at least all of the pages in a single document may be provided (high font similarity), and many documents could be input if the documents contain only a few pages or there exists an adequate amount of font similarity between the documents.

In operation 230, the system optionally compares each CI(cc) to a set of previously verified rs's for the respective cc, denoted “PVRS(cc)” 232. An individual previously verified rs is denoted “pvrs”. A set of pvrs's is denoted as “PVRS”. A pvrs for a respective cc is an rs that the system is confident the operator is think is correct. For each ci in a CI(cc) a comparison is made to each PVRS(cc). Any ci that closely matches a pvrs is considered validated and removed from CI(cc).

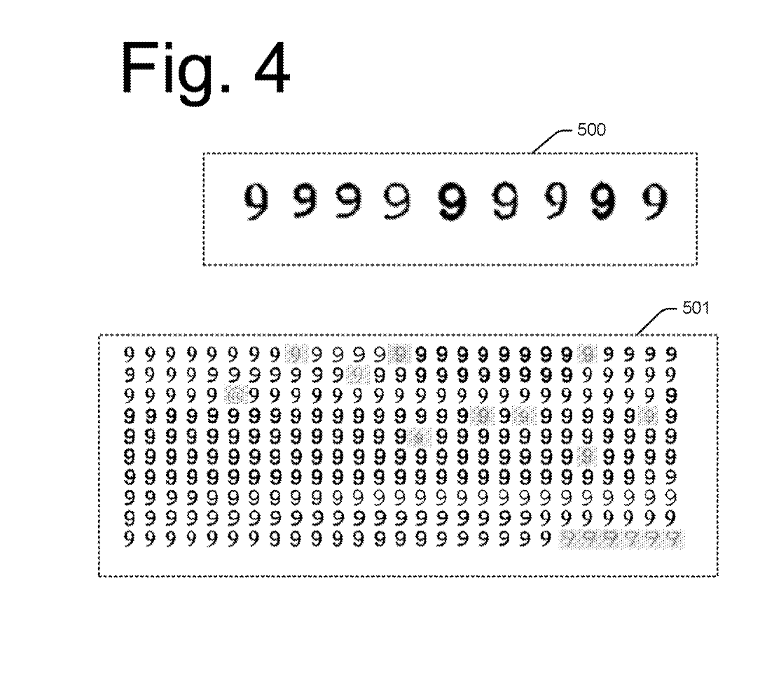

FIG. 4 is an example of what the rs within a PVRS 500 might look like and how PVRS can automatically validate CI. In this example, PVRS(cc=9) 500 is a PVRS(cc) for the number “9”. These shapes are in the PVRS(cc=9) because the system is highly confident that the OCR engine is correct when a ci that matches an rs in PVRS(cc=9) is given the cc of “9” by the OCR engine. The CI(cc=9) 501 shows highlighted “9”s which are the only ci that do not closely match the PVRS(cc=9). These are the only ci's that would need manual verification.

This step serves at least three purposes: 1) it increases human productivity because a smaller RS is required to handle the smaller CI. This is result in an operator having to review fewer rs's; 2) it decreases the processing required because the processing required to determine the elements of a best RS is a function of the size of CI, |CI|, and the best process has an approximate computational order of O(n²), where it is |CI|, while the brute force method has an approximate computational order of O(n!), and consequently, decreasing n improves the performance significantly; 3) it increases the accuracy of the system. With manual verification, the possibility exists that the operator is incorrectly identify something. As a result, reducing the rs's the operator has to verify reduces the rs's that is associated with the incorrect cc when verification is finished.

Another application of the PVRS is Auto Reclassification. This is the process of using PVRS to override the OCR process's initial cc guess. The contents of CI are compared to PVRS regardless of their respective cc's. If the closest rs a ci matches is found in a PVRS(cc′) where cc′≠cc, then the ci can be reclassified as cc′. This process has the effect of reducing the size of RS. If an image of a “6” was originally classified as a “9”, it is not match any of the rs's for the 9's, and it is require its own rs. If the “6” is reclassified to the 6's then it is match a rs of another “6” and not require an extra rs. This process also has the effect of reducing the obvious errors operators have to manually correct. Reclassification has to be done with care since it is possible that a partial image of a one character may appear to be a different character. For example, a partial “p” might look like an “o”. For that reason, appropriate match quality thresholds, which could be character specific, have to be considered to prevent making errors while reclassifying.

Multiple PVRS's may be generated. For example, in scenarios when it is known that a particular font is going to be seen again and again during OCR, it makes sense to create a PVRS for each font. Most of the time, the font is not directly known, but some other identifier associated with the font such as a form id is known. For example, when a single form is distributed to many entities to be filled out, the font used to print the form is the same for all of the forms that are returned. In this case and many other cases, it makes sense to maintain a PVRS(form_id) for each form being processed. PVRS(form_id, cc) would be the set of previously verified representative shapes for each character code of a particular form. As long as the input to the system includes the associated form id, the system can use the form-specific PVRS in addition to the non-form-specific PVRS. In this way, any data that was preprinted on the form could be more accurately read. Another type of identifier might be the entity id. When forms are printed by the entities who are also responsible for filling the forms out, the fonts used for the forms is vary with different entities. However, the font is consistent if an entity returns their form to the processing facility more than once. So, it makes sense to maintain a PVRS(entity_id) for each entity that fills out a form. PVRS(entity_id, cc) would be the set of previously verified representative shapes for each character code used by an entity. As long as the input to the system includes the associated entity id, the system can additionally use the entity specific PVRS. As a final example, if an entity has different fonts for different forms being processed, then it might make sense to maintain PVRS(form_id, entity_id). Other scenarios could exist where a set of PVRS would be keyed to some other set of identifiers that are associated with the font being used.

Auto Reclassification thresholds and character specific rules can be generated manually or automatically. An exemplary automatic technique is described as follows. If a ci of a particular entity or font is consistently recognized by the OCR process as a specific cc, but then consistently corrected to the same character cc′, then that particular ci would be considered for automatic reclassification. In the future, if any ci within the CI(cc) closely matches the particular rs within the PVRS(cc′) then that that ci could be safely reclassified to cc′.

It is noted that various techniques may be implemented to maintain each PVRS. Each PVRS can be created and maintained manually and/or automatically. Automated methods might include, but are not limited to, maintaining a larger set of potential pvrs's, PPVRS(x, y, . . . ) (where “x, y, . . . ” represents an arbitrary identifier set such as entity_id, form_id, etc) and using PPVRS( . . . ) to provide seed rs's for each CI(cc). Statistics may be automatically collected over time to track the accuracy of these seed rs's. As an obvious example, an “accurate” seed rs could be one that the operator did not flag as incorrectly associated with a cc. Then, when a seed rs reaches an empirically determined accuracy threshold, the rs could be added to the PVRS. Over time inaccurate rs's can be compared to elements of each PVRS to see if there are any close matches. Any pvrs that has a high match rate to inaccurate rs's might be removed from PVRS. It is noted that there are many other mechanisms to maintain each PVRS.

In operation 240 (FIG. 2), the system may then determine an optimal set of representative shapes for each character code, RS(cc), such that the representative shapes chosen best match the most character images in each CI(cc). The size of each RS(cc) is many times smaller than the size of each CI(cc).

Any bitmap comparison routine which results in a single value representing similarity can be used to compare a ci to another ci or to an rs. An exemplary similarity procedure is described below in Example 1. It is noted that multiple computers and/or processors may be utilized if the similarity calculation is time consuming.

There are at least two ways to find an RS. The first way is to use a predetermined RS. The second way is to determine an optimal RS for a given CI. The elements of a CI could be all the ci's for a particular cc or, on the other hand, any arbitrary set of character codes. The preferred embodiment is to group ci by cc and then produce rs for each cc. This is a more useful grouping for manual verification and correction.

An exemplary RS determination procedure for determining an optimal (or near optimal) RS for a given CI is described in more detail below in Example 2. “Nearly optimal” is used because determining the optimal set is very time consuming, and “nearly optimal” is acceptable for the purposes of OCR error correction—the goal is have the number of shapes within an RS be dramatically less than the number of ci's in a CI.

While the same similarity threshold for all characters codes is acceptable, different character codes might need different thresholds for determining similarity to shapes. For example, to better differentiate between characters like the number “zero” and the letter “O”, or between the number “one” and the letter “I” or “I”, a higher threshold of similarity may be desired.

It is noted that the count of ci's matching a given rs may also be used to automatically verify an rs because there is a relationship between the number of ci's matching an rs and the validity of the OCR process's guessed cc. Generally, if a tremendous number of ci's share the same rs, the likelihood of the guessed cc being correct is high. It is noted that various techniques may be implemented to maintain the ci count threshold for automatic validation. Statistics that cross-reference the accuracy of an rs to the count of ci's matching the rs may be automatically collected over time. For example, an “accurate” rs could be one that the operator did not flag as incorrectly associated with a cc. Any rs with ci match counts above the threshold could be automatically considered valid and removed from the set RS(cc) requiring validation. All ci's matching the validated rs could be removed from the set of CI(cc) requiring validation.

The remaining RS(cc) require manual validation. In an exemplary embodiment, a displayed rs may be the rs itself, representative style, or a composite image, composite style. A composite image might be generated by combining all the ci matching the rs. This produces a blurred image that is the locus of all the pixels of the underlying ci. Composite style may also use different colors and shades. Pixels in the composite image can be darker/lighter and/or different hues, depending upon the number of ci's that contributed to that pixel or other mathematical formula. Different levels of brightness and/or different hues may also be used to indicate the probability that a particular displayed ci, rs, or word is erroneous.

Different types of matrices may be implemented for the manual validation and correction process. Often times when just looking at a single ci or a single rs it is still necessary to see the context. The context could be the word containing the ci or the words containing all the ci's of the rs. This is referred to as investigating the ci or investigating the rs. Sometimes it is necessary to see the context of a word, which could be the page or a region of a page containing the word. This is referred to as investigating a word.

When investigating a ci there are at least two options: 1) the word containing the ci can be displayed. Note that the ci can be highlighted within the word; and 2) the page or a region of the page containing the word containing the ci can be displayed. Note that word can be highlighted and/or the ci within the word can be highlighted.

When investigating a word containing a ci, there is at least one option. The page or a region of the page containing the word containing the ci can be displayed. Note that word can be highlighted on the page and/or the ci within the word can be highlighted.

When investigating an rs, a word matrix or CI matrix may be displayed. A single rs represents many ci's. When investigating the rs, all of the ci's have to be displayed in some fashion. If a CI matrix is displayed, the operator has the option of further investigating a ci as described above. If a word matrix is displayed, the operator has the option of further investigating a word as described above.

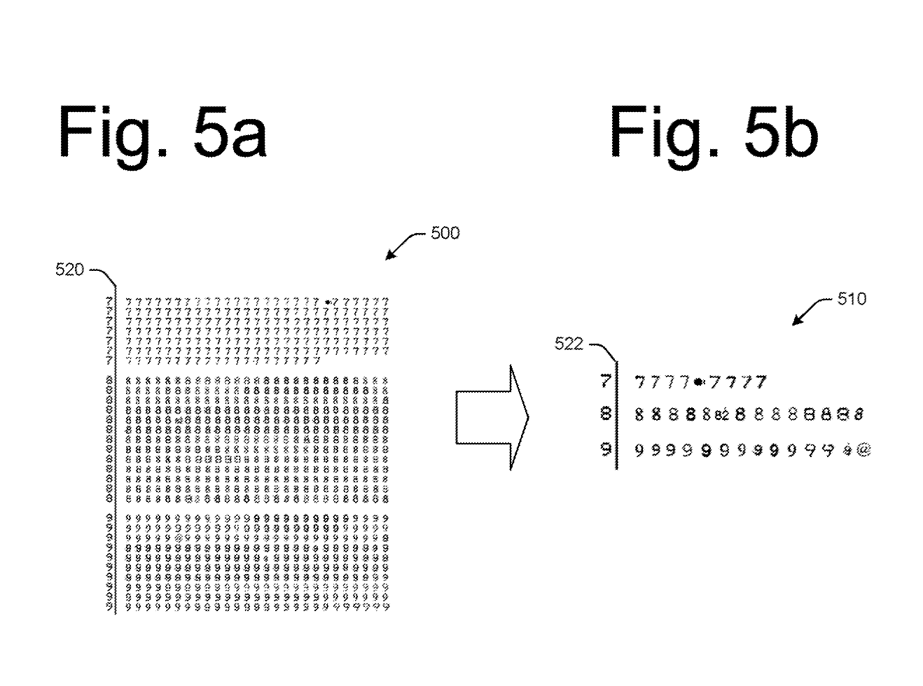

FIGS. 5a-b show exemplary matrices which may be displayed for a user for manual validation during high speed error detection and correction, wherein a) shows a character image (CI) matrix, and b-c) shows the CI matrix after it has been reduced to a representative shapes (rs) matrix.

In FIG. 5a, the CI matrix includes all the character images (ci) grouped by their character code (cc) for three different cc (7's, 8's, and 9's in this example). Using the systems and methods described herein, the CI matrix may be reduced to the representative shapes (rs) shown in FIG. 5b. In an exemplary embodiment, both the CI matrix and the rs matrix may be displayed for an operator so that the operator can see the characters in context. Also in exemplary embodiments, the character images may be scaled to be the same size as one another to ease visual inspection when the batches of documents contain a variety of different font sizes.

Both matrices 500 and 510 display the cc to the left of a vertical line or bar 520, 522. Matrix 500 displays the full CI(cc) to the right of the bar 520, while matrix 510 displays the much smaller RS(cc) to the right of the bar 522. Because a single rs may represent thousands of similar ci's, the number of character images an operator must look at during manual inspection and correction for a given number of documents is greatly reduced.

By grouping by cc, the operator already knows the OCR result of all the images in the group is supposed to be cc, and therefore the operator does not have to do a double-read review. Because the character images, when grouped by suspected cc, are so similar, incorrect characters stand out for easy discovery and correction. Because an error can be corrected at the character level rather than the word level, many keystrokes are saved. This review process is so efficient that all characters can be reviewed without having to filter based upon OCR engine confidence. This means there is not be any character mistakes which go unverified. When compared to existing methods, all of this translates into an increase in accuracy and a reduction of operator time and cost required for inspection/correction.

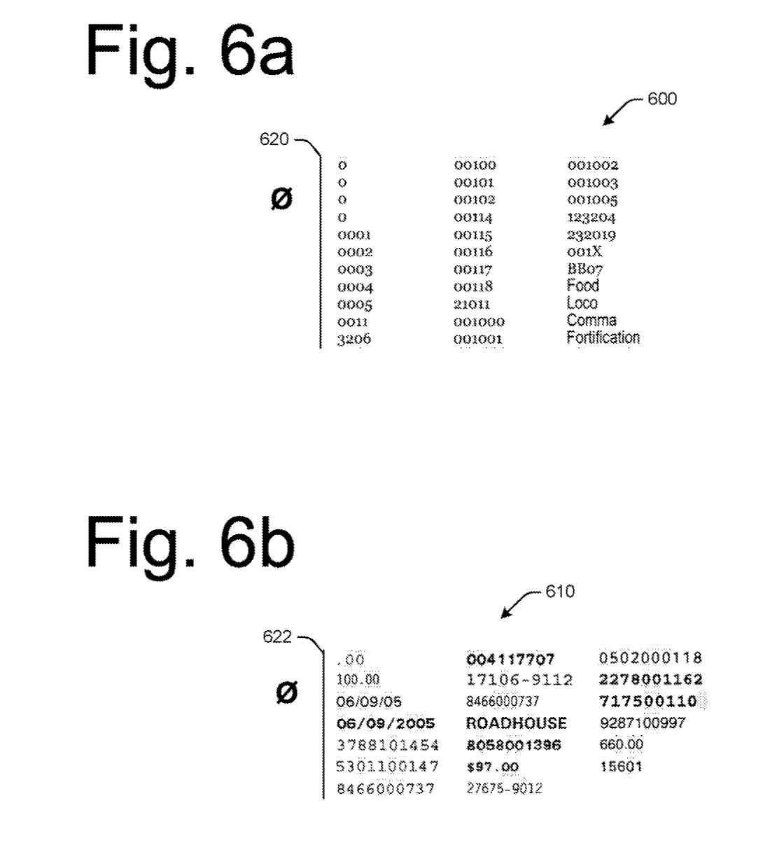

Other matrix layouts may also be used for manual validation of the OCR results. FIGS. 6a-b show other exemplary matrices which may be displayed for a user for manual validation during high speed error detection and correction, wherein a) shows an rs-word matrix containing all the words for a single rs, and (b) shows a ci-word matrix containing all the words for a CI(cc).

In the rs-word matrix 600, each word contains at least one ci from CI(cc). In the ci-word matrix, each word contains at least one ci matching rs from RS(cc). Highlighting the ci when displaying the results for the user helps the ci stand out within its word. In cases when two or more ci share the same word, it is only necessary to display the word a single time. If highlighting were used, both ci could be highlighted.

For purposes of illustration, note the high similarity of the zeros and letter “O”s in matrix 600 due to the fact that matrix is displaying only the words containing ci that matched a single rs from the set RS(cc=zero). In matrix 310, it is clear that there are a lot of different shapes and sizes for zeros and letter “O”s.

Again, the cc is shown to the left of a bar 620, 622, and the words of the cc are shown arranged on the right. In this embodiment, the next cc is displayed right below the previous, until the end of the screen is reached. More than one screen's worth of space may be required to display the entire CC.

It is noted that output is not limited to the examples shown in FIGS. 5a-b and 6a-b. Different types of visual arrangement may also be implemented. For example, users may be presented a single ci, rs, or word one at a time; the cc could be displayed anywhere relative to the ci's, rs's, or words; the cc might not be displayed at all; there could be other artwork such as border lines, shading, etc; there could be different coloring, sizing, spacing of particular images within the cells; there could be informative annotations on the cells or other areas; or users could be shown one cc at a time even if the page/screen were not completely filled.

In other exemplary embodiments, the ci's, rs's, or words may also be displayed in different ways. Inspection productivity benefits from a smooth transition from one image to the next because gradual changes can be comprehended by the eye during a fast scan. Additionally, different types of orderings can clump errors towards one end, making them easier to locate. With the CI matrix, sorts may include, but are not limited to: font, types of fonts, case, shape similarity and/or OCR confidence. Types of fonts might include but not be limited to handwriting, machine print, dot matrix, sans serif, and/or serif. With the RS matrix, possible sorts include but are not limited to: font, types of fonts, case, shape similarity, the number of ci and/or the average OCR confidence of the ci that matched the rs. Generally, the rs's with the fewest ci matches are the bad rs's, so sorting by that count is good for clumping errors. With the word matrix, assuming the display of all words containing ci from an arbitrary CI or ci that matched a single rs, possible sorts include but are not limited to: the physical length of the word, the number of characters in the word, number of ci's in the word, the number of alpha characters in the word, the number of numerical characters in the word, the position within the word of the ci's, average OCR confidence of the cc's of just the ci's in the word, average OCR confidence of all the cc's in the word. Different horizontal alignments of the words within the cells of the word matrix are possible as well.

In an exemplary embodiment, the RS matrix is initially presented to the operator, and the other types of matrices may be used for contextual investigation of questionable rs's. The operator proceeds to inspect each rs in each RS(cc) by quickly scanning the set looking for anomalies. By inspecting a single rs, the operator is inspecting all of the ci's that are most similar to that rs. It is readily apparent from a comparison of matrices 500 and 510 in FIGS. 5a-b that the number of ci's an operator must look at in matrix 500 for a given number of documents is much greater than the number of rs's in matrix 510 for the same number of documents.

Upon noticing an error, the operator can use the mouse, keyboard, touch screen, stylus, touchpad, voice interface, and/or any other input device to select the cell containing the error. Depending upon the matrix the operator is looking at, the cell could contain a ci, rs, or word. In the word matrix, the operator could have the additional option of selecting an individual ci within the word.

Once an rs, ci, or word is selected, the operator can enter the correct cc or entire word; enter a contextual view, from which similar options are available; or indicate that the cc is unknown and should be reviewed later; or perform specialized tasks described below. As a side note, as much as possible, as soon as rs's, ci's or word images are selected, the appropriate context should automatically be displayed. Segmentation errors can cause double (or more), partial, or garbage character images. If the displayed “character” image (ci, rs, or highlighted ci within a word) is of more than one actual printed character, the operator should be allowed to enter more than one cc. If the displayed “character” image (ci, rs, or highlighted ci within a word) is garbage or blank, the operator should be allowed to delete the cc. In the event the displayed “character” image (ci, rs, or highlighted ci within a word) is a partial image of the actual printed character, the operator should be allowed to delete or key the cc. However, when there is a partially segmented image, it is likely that the other half was partially segmented as well and is in a different cc group. Since the operator has no way of knowing if there were two erroneous characters put in separate cc groups, or if any operator is notice the other half, or how the second half is corrected (deleted or keyed), it is more likely that the cc could be deleted or duplicated that it be corrected. To avoid this, the operator should be allowed to key the entire word whenever the contextual word is available. When correcting an entire word or a single ci, there has to be some logic to decide what to do in the event an intersecting rs is corrected afterwards. Intersection meaning an rs that matched a ci that has been corrected individually or as part of a word. The preferred embodiment is to give precedence to the correction made to an individual ci.

The final output of the system is the corrected OCR generated from the automatic and manual corrections.

It is noted that operation 240 (FIG. 2) may be executed in parallel where the operators work to validate different work, or in series where the work is validated more than one time to insure accuracy. The representative shapes within each RS(cc) are presented to one or more operators for manual inspection in operation 250. If the operator observes an rs that represents ci's that did not have the correct cc assigned to them, the operator can quickly correct all the ci's with one command.

The system may automatically update the appropriate PVRS's through a variety of analysis, e.g., using statistical information 252. Accordingly, the output may be corrected cc's 254 and the information required for linking the corrected cc's back to the original input. In addition, other parts of the input data and operator performance statistics may also be included in the output. The output may then be implemented to correct OCR text streams.

In exemplary embodiments, long running operations may be executed earlier and their results stored in a format that can be loaded and presented to the operator as fast as possible. In other embodiments, however, some or all of the operations may be executed while the operator waits.

It is noted that the operations shown and described herein are provided to illustrate exemplary embodiments and are not intended to be limiting. For example, the operations are not limited to any particular ordering, the operations may be modified, and still other operations may also be implemented to enable high speed error detection and correction for character recognition.

### EXAMPLE 1

### Similarity Procedure

A similarity procedure may be used to compare two ci's or a ci to an rs. Similarity is expressed as a floating point number between 0 and 1.0. The value of 0 means the procedure gave up trying to compare because the shapes were too different. The value of 1 means the shapes are exactly the same. Results in the range from 1 to 0 represent lessening degrees of similarity.

The similarity procedure may be performed on a given ci many times by the RS Procedure. An exemplary similarity procedure is as follows:
Scale all ci to the same dots per inch.
Pre-calculate re-used intermediate values and store them with the ci data. These values may include, but are not limited to: dots per inch; max width; max height; black pixel count; centroid; distance from centroid to top, bottom, left, and right of bitmap; moment; and integers representing the unraveled 5×5 and 3×3 matrices at each point in the ci.
Exit, returning the minimum similarity when it becomes clear that the calculation is going to return a similarity below a certain threshold.
Pre-calculate all convolution results and store them in lookup tables. Pre-calculation is possible for 1 bit per pixel bitmaps, because the number of results is small enough.

For purposes of illustration, two ci's (referred to as images A and B) may be compared. The following notation is used in this example:
\vec{p}=Pixel. A pixel is single x, y coordinate in a bitmap. A bitmap is an m by n matrix of coordinate locations. A pixel location can include a one or a zero representing a black or white dot. A pixel is a 2-dimensional vector.
A,B=Sets of all pixels in the two bitmaps
A¹, B¹=Sets of all black pixels in A,B
A^{b}=A¹-B¹=Set of all black pixels in A that do not overlap black pixels in B
B^{a}=B¹-A¹=Set of all black pixels in B that do not overlap black pixels in A

1. To avoid the more intensive calculations following this step, perform some quick checks to throw out obvious non similar bitmaps.
a. Compare max width and max height of each image. The max height is the vertical distance between the top-most pixel and the bottom-most pixel. The max width is the horizontal distance between the left-most pixel and the right-most pixel. The max heights and max widths must be within a certain threshold for there to be any similarity. Alternately, the images can be scaled to have the same max height and max width and then the comparison can continue. For performance reasons, if this scaling were performed, it may be performed on all ci's prior to any comparison.
b. Compare the pixel count for each image. The counts must be within a certain threshold of each other to have any similarity.

2. Calculate the centroid, \vec{c}ₐ, \vec{c}_{b}, of each image.

$$I = \{ {A}^{1} , {B}^{1} \}$$

$$\vec{c} = \frac{{\sum }_{i ∈ I} i}{\vert I \vert}$$

3. Align the coordinate systems of A and B on their centroids.

4. Optionally, adjust the centroid alignment by a couple pixels in the horizontal and vertical directions. This is accomplished by minimizing the distances of all non overlapping pixels from the mass of overlapping pixels. The idea is to get the two images as aligned as possible before we do the comparison. The following 3×3 matrices are suitable for calculating a factor of distance for 1 pixel offsets. If greater pixel offsets are desired, larger matrices are needed; however, large offsets are indicators of non-similarity. Since we are trying to calculate similarity, the smaller matrix is adequate and higher performance as well.

$${M}_{y} = [ \begin{matrix}- .7 & - 1 & - .7 \\ 0 & 0 & 0 \\ .7 & 1 & .7\end{matrix} ]$$

$${M}_{x} = [ \begin{matrix}- .7 & 0 & .7 \\ - 1 & 0 & 1 \\ - .7 & 0 & .7\end{matrix} ]$$

$$M = \{ {M}_{x} , {M}_{y} \}$$

Perform the convolution for each matrix in M and for each bitmap A, B. Convolve the matrices M over B at pixel locations in A^{b}. Convolve the matrices M over A at pixel locations in B^{a}.

$$I = \{ {A}^{b} ⋂ B , {B}^{a} ⋂ A \}$$

$${f}_{IM} = \frac{{\sum }_{i ∈ I} i ⊗ M}{\vert I \vert}$$

This results in 4 separate factors. When using Mₓ and M_{y}, the results form a vector. Since I is the set A, B there are two vectors (\vec{f}ₐ, \vec{f}_{b}) coming from the 4 factors. Subtract B's vector from A's.

\vec{f}=\vec{f}ₐ−\vec{f}_{b}

This vector is an approximate measure of the horizontal and vertical misalignment of A and B. Larger values correspond to more misalignment. If the alignment in a direction is greater than a threshold, the bitmaps may be shifted by 1 pixel. The calculation may be performed iteratively to find the minimal solution.

5. To avoid the more intensive calculations following this step, perform some quick checks to throw out obvious non similar bitmaps.
a. Count the pixels that overlap. The overlap count must be above a certain threshold for there to be any similarity. This threshold might be percentage based to account for different sized images. If the optional alignment adjustment step is performed, the overlap count could come from that; otherwise, this must be calculated.
b. The distance measured from the centroid to the top black pixel, or to the left black pixel, or to the right black pixel, or to the bottom black pixel must be similar between A and B within a threshold.

6. Calculate a representation of the difference between A and B. This can be represented as the sum of the distance to the nearest pixel for each non overlapping pixel.

Each one of these matrices represents a different nearest pixel. They are tried in the order given here (M1, M2, M3, M4, M5). Whichever matrix returns a non 0 result first determines the distance to the nearest pixel.

$${M}_{1} = [ \begin{matrix}0 & 1 & 0 \\ 1 & 0 & 1 \\ 0 & 1 & 0\end{matrix} ]$$

$${M}_{2} = [ \begin{matrix}1 & 0 & 1 \\ 0 & 0 & 0 \\ 1 & 0 & 1\end{matrix} ]$$

$${M}_{3} = [ \begin{matrix}0 & 0 & 1 & 0 & 0 \\ 0 & 0 & 0 & 0 & 0 \\ 1 & 0 & 0 & 0 & 1 \\ 0 & 0 & 0 & 0 & 0 \\ 0 & 0 & 1 & 0 & 0\end{matrix} ]$$

$${M}_{4} = [ \begin{matrix}0 & 1 & 0 & 1 & 0 \\ 1 & 0 & 0 & 0 & 1 \\ 0 & 0 & 0 & 0 & 0 \\ 1 & 0 & 0 & 0 & 1 \\ 0 & 1 & 0 & 1 & 0\end{matrix} ]$$

$${M}_{5} = [ \begin{matrix}1 & 0 & 0 & 0 & 1 \\ 0 & 0 & 0 & 0 & 0 \\ 0 & 0 & 0 & 0 & 0 \\ 0 & 0 & 0 & 0 & 0 \\ 1 & 0 & 0 & 0 & 1\end{matrix} ]$$

$$M = \{ {M}_{1} , {M}_{2} , {M}_{3} , {M}_{4} , {M}_{5} \}$$

Perform the convolution for each matrix in M and for each bitmap A, B by convolving the matrices M over B at pixel locations in Ab and the matrices M over A at pixel locations in Ba.

I={A^{b}∩B, B^{a}∩A}

Each matrix has a different error weight for its non zero convolution results.

{f₁,f₂,f₃,f₄,f₅,f₆}=series of weights for each distance matrix.

$$Where {f}_{1} \leq {f}_{2} \leq {f}_{3} \leq {f}_{4} \leq {f}_{5} \leq {f}_{6}$$

$${f}_{a , b} = {\sum }_{n ∈ I} \{ \begin{matrix}I ( n ) ⊗ {M}_{1} \geq 0 \vert {f}_{1} \\ I ( n ) ⊗ {M}_{2} \geq 0 \vert {f}_{2} \\ I ( n ) ⊗ {M}_{3} \geq 0 \vert {f}_{3} \\ I ( n ) ⊗ {M}_{4} \geq 0 \vert {f}_{4} \\ I ( n ) ⊗ {M}_{5} \geq 0 \vert {f}_{5} \\ I ( n ) ⊗ {M}_{5} = 0 \vert {f}_{6}\end{matrix} \}$$

For each term in the sum, use the weight that is associated with the first non-zero convolution result. As shown above, each matrix has an associated distance weight. That becomes the weight for that non overlapped pixel in the image. If non of the convolutions returns a non-zero value, assign a large distance value—this indicates a pixel that is very far from other pixels on the other image.

As the final step, sum the squares of the weights for A and B. Then, normalize the sum by dividing by the count of non-overlapping pixels times the maximum possible distance weight. The result is the measure of the difference between the images A and B. For aesthetic purposes, subtract the result from 1 to come up with the similarity factor between 0 and 1.

$$S = 1 - \frac{\sqrt{{f}_{a}^{2} + {f}_{b}^{2}}}{( \vert {A}^{b} \vert + \vert {B}^{b} \vert ) {f}_{6}}$$

### EXAMPLE 2

### RS Determination Procedure

In this example, we document a viable, sample process for determining a set of representative shapes (RS) for a given set of character images (CI). This process is referred to as the RS Procedure. As one might suspect, the problem of finding an RS that is the optimal balance between computational time, error, and required user interaction is a difficult problem to solve. Here, one solution that combines preprocessing the Cl, removing items that are known to be historically accurate, and finally heuristically searching for an optimal set is presented.

Throughout this example, the following definitions are used:
DPI=Dots (pixels) per inch.
cc=Character code (ASCII, UNICODE, etc).
ci=A single character image.
CI=A set of character images.
rs=A single representative shape.
RS=A set of representative shapes.
RSₑ=The RS with the minimum error (the optimal RS).
rsₑ=An rs which belongs to RSₑ.

The first significant part of the RS Procedure is to preprocess a given CI where the parameters of each preprocessing step are configurable by the character code (cc) of the CI. Configuration of the parameters is accomplished using statistical, historical, and/or user input.

The first step of the preprocessing is to reduce each ci to the smallest DPI possible for accurate processing—this is approximately 200 DPI. This step primarily serves to normalize the size scale of all of the ci's and make the computations simpler.

Second, to further enhance the similarity of the shapes, each ci in the CI is scaled to a configured height and width. To improve the accuracy of this scaling, pixel clumps (dots) below a configurable threshold can be disregarded. Additionally, the change of the ci's aspect ratio is also be configurable. When the change does not drastically affect the shape to the point that manual verification is needed, changing the aspect ratio of the ci is increase the accuracy of the RS Procedure.

The third and final preprocessing step is an algorithm to remove pixel noise from each ci. The characteristic threshold of pixel size for the noise removal is the primary configurable parameter for this step.

Once preprocessing is completed, the task at hand is to compute the best RS for the CI. The selected entries for an RS is a pool of shapes that essentially summarize all of the shapes of the CI. By then computing the similarity factors of each ci to each rs in the RS, sci, the ci's are grouped around the rs which best represents their particular shape. The optimal RS, RSe, is defined as the RS that simultaneously minimizes its size and error. The size of an RS, |RS|, is simply the number of elements in it. The error of an RS is given as:

$$E ( RS , CI ) = 1 - \frac{( {\sum }_{rs ∈ RS} {\sum }_{s ∈ {CI}_{rs}} {s}_{ci} ) + \vert {CI}_{x} \vert {f}_{x}}{\vert CI \vert}$$

Where the following definitions are used:
CIᵣₛ=Subset of elements of CI that match rs.
CIₓ=Subset of elements of CI that do not match any rs.
fₓ=Difference factor for the ci's contained in CIₓ.
s_{ci}=Similarity factor for a ci in CIᵣₛ.

Selection of the elements of an RS which is a candidate for RSe can be done in a variety of ways. The method used by the RS Procedure is to select the elements of the candidate RS's from the CI itself. For each candidate RS, then, the number of comparisons required to perform the grouping task Nc, is provided by the below equation.

N_{c}=(|CI|−|RS|)|RS|

However, this is not the ideal method because it is highly unlikely that the ci's in Cl, alone, is produce the global. RSe. This is clear from the following argument: if an RSe is created with only ci's from CI, another RS with lower error can be produced by creating new rs's that are averages of the ci's that are grouped around the rs's in RSe. Since such an RS, almost always, results in a lower error, the original RSe could not be the optimal set by contradiction. Furthermore, such an RS created by averaging is not easy to compute since the ci's to select for the initial RS to be averaged around do not stand out in anyway. Consequently, much computation time would have to be spent finding an initial RS to perform the averaging around. Nevertheless, this method is shown to produce an RS that is a satisfactory approximation to RSe.

Naturally, the error of the RS is inversely proportional to the size of the RS. In other words, as the RS grows in size, more elements are selected from CI. Consequently, each ci in the CI has a better probability of being exactly represented. In the limit where |RS|=|CI|, the error is 0—all of the elements in the CI is exactly represented by one rs element in the candidate RS.

$${lim}_{\vert RS \vert \to \vert CI} E ( RS , CI ) = 0$$

The downside of choosing an RS with zero-error is that the size of the RS is now the size of the CI. In turn, this means the operator is have to visually check |CI| elements which is clearly a very time consuming task. On the other side of the extreme, as the RS decreases in size, both the error and the number of instances of unrepresented ci's (ci's that cannot be adequate matched to any rs in RS) increase. So, to reiterate, the problem is to find an acceptable balance between the error and the size of the RS.

The variance in the shapes included in the CI grows proportionally with |CI|. Consequently, an algorithm where |RS| is constant for all CI's is experience increasing error with increasing |CI|.

Further, the amount of shape-variance of the ci's is anisotropic with respect to their respective cc's. For example, there are fewer ways to display a “0” (zero) then there are an “a.” As a result, the average |RSe| for the cc of “a” should be larger than the average |RSe| for the cc of “0.” To quantify this shape-variance, the quantity k(cc) is defined as a function that is return a numerical value which represents the relative shape variance of the given cc. The larger the amount of shape-variance a cc has, the larger the value k(cc) is return.

The solution which the RS Procedure implements is to make the size of the candidate RS's a function of |CI|, k(cc), and G(|CI|). G(|CI|) is a function which depends only on |CI| that allows |RS| to scale non-linearly with respect to |CI|.

|RS|=k(cc)G(|CI|)|CI|

The optimal behavior of k(cc) and G(|CI|) are not completely known and often hard to predict. Consequently, these functions are continually configured based upon testing, historical data, and feedback loops.

The above equation only serves as the suggested starting point in the RS Procedure. |RS| is actually tuned in real-time as calculations are preformed to meet user-enforced boundaries on the output. For example, if the error of the RS candidates is below a certain threshold, the RS Procedure is capable of recalculating new RS candidates with a decreased size. On the other hand, if |CIx| is too large, the RS Procedure can try to create RS candidates or increased size.

The brute-force method of computing the best candidate RS from all of the possible RS's is a computationally demanding problem. The amount of possible combinations of ci's that can form a candidate RS, Np, is given by the below equation.

$${N}_{p} = \frac{\vert CI \vert !}{\vert RS \vert ! ( \vert CS \vert - \vert RS \vert )}$$

Then, as discussed above, Nc comparisons must be made to calculate the error of each RS. So, the total number of calculations, NT, is approximated as (Np)(Nc).

$${N}_{T} = {N}_{p} \cdot {N}_{c} = \frac{\vert CI \vert !}{\vert RS \vert ! ( \vert CS \vert - \vert RS \vert ) !} \cdot ( \vert CS \vert - \vert RS \vert ) \vert RS \vert$$

Since, in practice |CI|>>|RS|, the computational order of the brute force method is approximately (|CI|!).

N_{T}˜O(|CI|!)

A factorial computational order grows drastically fast with increasing input size (|CI|). Consequently, the RS Procedure takes steps to reduce the input size using the historically formed elements of the PVRS.

Before the RS candidates are formed, the similarity routine of Example 1 is executed for every ci in CI against every rs in. PVRS. Elements of CI which have an acceptable similarity to an rs in PVRS are considered verified and are subsequently removed from the CI. Clearly, this has the effect of reducing |CI| and |RS| which in turn reduces the number of shapes that the human operator has to manually verify. Further, since the PVRS is historically formed from known correct cc⇄ci relationships, the elements remaining in the CI are more likely to be incorrect.

Even with the PVRS filtering process, |CI| is still usually too large for the brute force approach to be computationally practical. However, the problem of forming RSe has the characteristics of a well behaved problem that is approachable with heuristic search techniques such as, but not limited to, Genetic Algorithms and Simulated Annealing. In the interest of efficient computation, these heuristic search algorithms is not yield the optimal RSe. However, they is yield a satisfactory solution. This is acceptable because a large cost in computation time is exchanged for only a slight increase in size of the final RS that is manually verified.

For the RS Procedure presented here, a Genetic Algorithm (GA) is the chosen heuristic search algorithm because of prior familiarity with the approach. The remainder of the example 1ddresses the GA used by the RS Procedure and assumes the reader is familiar with the fundamentals of GA's. The following definitions is used:
g=The number of organisms in a generation.
g_{d}=The number of organisms that die at the end of a generation.
gᵢ=The number of organisms that immigrate into the population at the end of a generation.
Nₘₐₓ=The maximum number of generations.
Eₘᵢₙ=The minimum error for the approximate RSₑ.

In the first generation, a total of g RS's are created by randomly selecting ci's within the CI as elements of the each RS. Each created RS is an organism in the population. Then, each organism is ranked using the error function, E(RS, CI) as previously defined in this example. Evaluating the error function, of course, requires running the similarity procedure from Example 1 on each rs-ci combination for each organism.

After ranking the initial generation, the gd organisms with the highest error are killed by removing them from the population of organisms. Then, the remaining (g-gd) organisms randomly exchange some of their rs elements between each other. Finally, gi new organisms are randomly created and introduced into the organism set. This new set of organisms in then re-ranked as described above. The killing-randomization-immigration-ranking process—referred to as the evolution of a generation”—is repeated until an organism in the set has an error below Emin or the number of generations reaches Nmax. In either case the organism with the lowest error in the set is used as RSe.

Using fundamental GA theory, this reduces the computation order significantly.

N_{T}˜O(ng(⊕CI|−|RS|)|RS|)

Then, if ng|RS|≈|CI|, the computational order of magnitude becomes which is significantly better than factorial.

N_{T}˜O(|CI|²)<<O(|CI|!)

In addition to the specific embodiments explicitly set forth herein, other aspects and embodiments is apparent to those skilled in the art from consideration of the specification disclosed herein. It is intended that the specification and illustrated embodiments be considered as examples only.

1. A method comprising:
grouping character images (ci) by suspected character code (cc) to generate a set of CI(cc);
displaying the set of CI(cc) for manual verification;
determining a set of RS(cc) of representative shapes (rs) of character images codes for each CI(cc); and
displaying the set of RS(cc) for manual verification.

2. The method of claim 1 further comprising displaying all words intersecting CI(cc), RS(cc), and /rs.

3. The method of claim 2 further comprising displaying a word grid and/or ci grid when an operator is unsure about an rs or ci.

4. The method of claim 2 further comprising displaying a word in context of a page or part of the page when the operator is unsure about the word.

5. The method of claim 1 further comprising defaulting to a word grid, rs grid, or ci grid based on the cc.

6. The method of claim 1 further comprising preventing display of words or context based on operator security levels.

7. The method of claim 1 further comprising ordering a word grid based on at least one of the following: a count of letters in a word, a count of numbers in a word, alphabetically, confidence level, count of characters in a word, and a physical size of a word appearing on a document.

8. The method of claim 1 further comprising ordering an rs grid based on at least one of the following: a number of ci that an rs represents, an overall confidence of all ci of an rs, similarity between adjacent rs, and a physical size of the rs appearing on a document.

9. The method of claim 1 further comprising ordering the ci within a grid based on at least one of the following: similarity between adjacent ci, confidence of each ci, and by physical size of the ci appearing on a document.

10. The method of claim 1 further comprising using one or both of color and display intensity to indicate a probability that a ci or rs is classified with an incorrect cc.

11. The method of claim 1 further comprising receiving operator input indicating if a ci or rs is classified with an incorrect cc.

12. The method of claim 11 wherein the operator input indicates partial or double ci or rs.

13. The method of claim 1 further comprising auto-verifying an rs using counts of ci that an rs represents.

14. The method of claim 13 further comprising determining a ci count threshold for auto-verification of rs by statistically analyzing results of one or more operators working an image conversion process over a period of time.

15. The method of claim 1 further comprising creating a set PVRS(cc) of previously verified representative shapes (PVRS) for each character code (cc).

16. The method of claim 15 further comprising creating the PVRS by statistically analyzing results of one or more operators working an image conversion process.

17. The method of claim 15 further comprising generating sets of PVRS(form_id, cc) for a particular preprinted form.

18. The method of claim 15 further comprising generating sets of PVRS(entity_id, cc) for a particular submitter of a form.

19. The method of claim 15 further comprising using PVRS(cc) to automatically verify ci or rs in order to reduce a number of images in the sets CI(cc) and/or RS(cc).

20. The method of claim 19 further comprising generating PVRS automatic verification thresholds by statistically analyzing results of one or more operators working an image conversion process over a period of time.

21. The method of claim 15 further comprising using PVRS(cc) to automatically reclassify ci or rs to different cc.

22. The method of claim 21 further comprising generating PVRS reclassification thresholds by statistically analyzing results of one or more operators working an image conversion process over a period of time.

23. A system comprising:
an imaging device configured to image at least one document;
an optical character recognition (OCR) engine operatively associated with the imaging device, the OCR engine generating a plurality of character images (ci) from the at least one imaged document; and
error detection and correction logic executing on a processor to:
group ci by suspected character code (cc) to generate a set of CI(cc);
output the set of CI(cc) for manual verification;
determine a set of RS(cc) of representative shapes (rs) of character images for each CI(cc); and
output the set of RS(cc) for manual verification.

24. A system for high speed error detection and correction comprising:
means for obtaining character images (ci) from at least one document;
means for grouping the ci by suspected character code (cc) to generate a set of CI(cc);
means for displaying for a user the set of CI(cc) for manual verification and correction if necessary;
means for determining a set of RS(cc) of representative shapes (rs) of character images for each CI(cc); and
means for displaying for the user the set of RS(cc) for manual verification and correction if necessary.
